(19) United States
(12) Patent Application Publication
(10) Pub. No.: US 2026/0266319 A1
(43) Pub. Date: Sep. 10, 2026

(54) RETAINING CLIP AND CLAMPING DEVICE FOR CLAMPING AND ORIENTING A RETAINING CLIP OF THIS TYPE

(71) Applicant: Komax Taping GmbH & Co. KG, Burghaun (DE)

(72) Inventors: Steffen SCHMELZ, Geisa (DE); Nick PROTZMANN, Geisa (DE)

(73) Assignee: Komax Taping GmbH & Co. KG, Burghaun (DE)

(21) Appl. No.: 19/491,418

(22) PCT Filed: Apr. 15, 2024
(86) PCT No.: PCT/EP2024/060197

§ 371 Date: Dec. 9, 2025

(30) Foreign Application Priority Data
Jun. 21, 2023 (DE) 20 2023 103 446.2

(51) Int. Cl. F16B 2/10; F16B 5/00

(52) U.S. Cl. CPC F16B 2/10; F16B 5/0012

(57) ABSTRACT

A retaining clip has a gripping region with two positioning elements pointing away from one another. Each of the positioning elements have, over their periphery, at least one ramp, which ramps are complementary to ramps of the clamping jaws of a clamping device. Thus, during gripping, the retaining clip can be easily clamped, oriented and centered.

The invention relates to a retaining clip having a gripping region configured for being gripped by a clamping device.

Furthermore, the invention relates to a clamping device for clamping and orienting the one retaining clip according to one of the preceding claims, having two clamping jaws that can be moved relative to one another.

A retaining clip having a clamping device is known, for example, from EP 3 796 493A1. The retaining clip has a pine tree profile for attachment to a further component, and an attachment bar. The attachment bar serves for attachment of a line element. The clamping device clamps the retaining clip against the attachment bar, so that the ends of the latter project. It is disadvantageous, however, that the retaining clip can be displaced in the clamping device or grasped at different locations.

Furthermore, a retaining clip and a tool for placement of the retaining clip have become known from DE 196 33 058A1. The retaining clip has two shanks, each having a wrap for attachment to a further component. The tool has a channel into which the retaining clip is introduced, so that the shanks are compressed. This retaining clip is thereby limited in terms of its possible shapes. Furthermore, the retaining clip can twist in the tool, so that precise positioning is not guaranteed.

The invention is based on the problem of further developing a retaining clip of the type stated initially, so that it is reliably centered and oriented when it is clamped using the clamping device. Furthermore, a clamping device is to be created, which allows reliable orienting and centering of the retaining clip when it is clamped in place.

The first problem mentioned is solved, according to the invention, in that the gripping region has at least one positioning element that projects or is set back, that at least one ramp extends over the entire circumference of that at least one positioning element, and that the at least one ramp is inclined relative to the axis of the positioning element.

By means of this embodiment, the gripping region is separated from other components of the retaining clip. The regions of the retaining clip that are situated outside of the gripping region can therefore be configured in almost any desired manner. This separation allows the production of a retaining clip that is standardized for different functions in the gripping region, such as holders for line sections or attachments of components to structures, for example components of motor vehicles. Thanks to the invention, the gripping region has a shape such that the ramps of the gripping region can be configured to correspond to ramps of the clamping device. The ramps can optionally run linearly or be arched. During gripping and thereby during clamping using the clamping device, the retaining clip is reliably centered and oriented.

The retaining clip is structured, according to another advantageous further development of the invention, in terms of design, in a particularly simple manner, if the projecting positioning element has an arched cone-like or pyramid-like shape.

If the material thickness of the retaining clip is sufficient, projecting positioning elements can easily be avoided if, according to another advantageous further development of the invention, the set-back positioning element has a funnel shape.

According to another advantageous further development of the invention, the retaining clip has a particularly simple design if the at least one positioning element is structured to be non-round in cross-section. By means of this embodiment, the at least one positioning element allows easy gripping by means of the ramps, by means of correspondingly shaped clamping jaws. Due to the non-round configuration of the positioning element, the retaining clip can be easily grasped so as not to rotate. In the simplest case, the at least one positioning element is configured to be rectangular in cross-section.

Particularly tilt-proof gripping of the retaining clip can be ensured, according to another advantageous further development of the invention, if the retaining clip has a positioning element, in each instance, on two sides that face away from one another.

The positioning elements have the capacity of supporting great forces, according to another advantageous further development of the invention, if the axes of the two positioning elements align.

It contributes to further simplification of the design structure of the retaining clip, according to another advantageous further development of the invention, if the at least one positioning element projects out from an attachment bar provided for attachment to a line element.

According to another advantageous further development of the invention, the retaining clip can be gripped in any desired orientation if the gripping region of the retaining clip is configured symmetrically, with two positioning elements that are the same. By means of this embodiment, orientation of the retaining clip in the clamping device is not necessary.

It should be possible to grip asymmetrical retaining clips with the clamping device, in the correct position. An orientation of the retaining clip in the clamping device, which orientation is intended, can be easily ensured, according to another advantageous further development of the invention, if the gripping region of the retaining clip is configured to be asymmetrical. The asymmetrical configuration of the gripping region can be obtained, for example, in that the gripping region has only one positioning element or has different positioning elements on different sides.

The second problem mentioned, namely the creation of a clamping device that makes reliable orienting and centering of the retaining clip possible during placement, is solved, according to the invention, in that at least one of the clamping jaws has a clamping element that is structured to correspond to the positioning element of the retaining clip.

By means of this configuration, the clamping device and retaining clip are shaped, in their regions that abut one another, in such a manner that the clamping element supports the positioning element during gripping, in every direction of space. In this way, reliable orienting and centering of the retaining clip is made possible during gripping and clamping.

The clamping device has a particularly simple structure, in terms of design, according to another advantageous further development of the invention, if the at least one clamping element has ramps that have a structure that is complementary to the ramps of the retaining clip.

Reliable tilt-proof clamping of the retaining clip can easily be achieved, according to another advantageous further development of the invention, if the movement direction of the clamping elements runs in the axis direction of the at least one positioning element during gripping.

According to another advantageous further development of the invention, the retaining clip can be gripped particularly reliably if the clamping jaws each have a clamping element.

The invention permits numerous embodiments. For further clarification of its basic principle, two of these are shown in the drawing and will be described below. The drawing shows, in

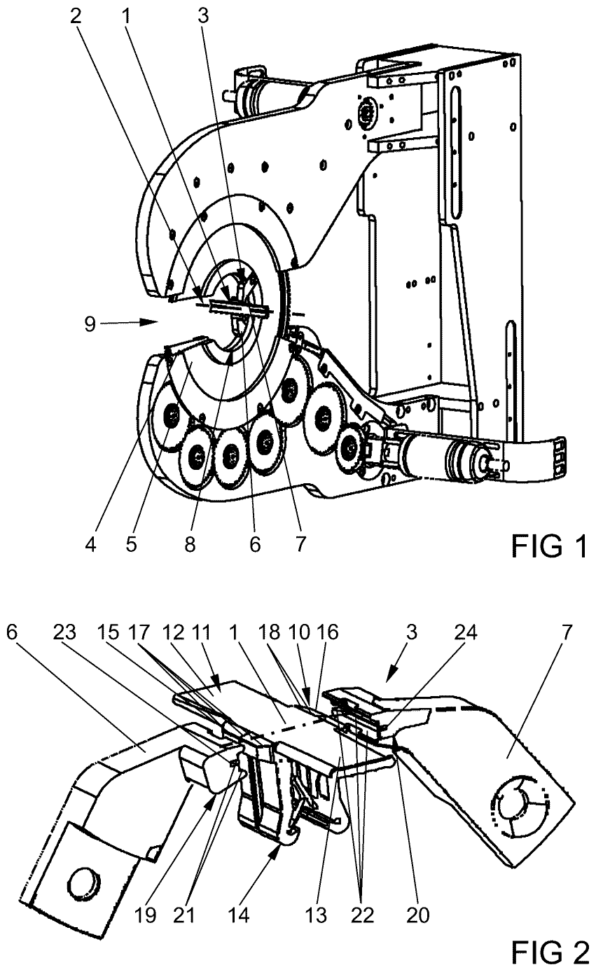

FIG. 1 in perspective, an apparatus for mounting of a retaining clip on a line element,

FIG. 2 enlarged, a partial region of a clamping device of the apparatus from FIG. 1, with the retaining clip,

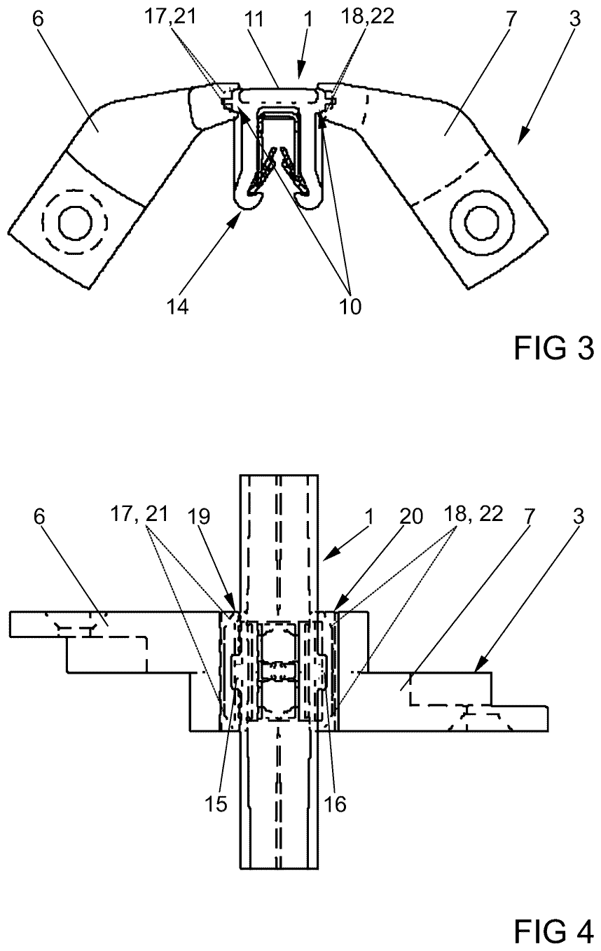

FIG. 3 the clamping device during gripping of the retaining clip from FIG. 1, from the side,

FIG. 4 the clamping device during gripping of the retaining clip from FIG. 1, in a top view

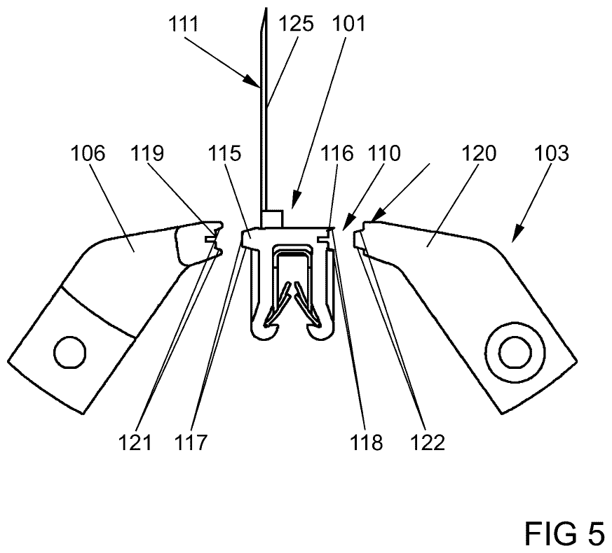

FIG. 5 a further embodiment of a retaining clip, with a clamping device.

FIG. 1 shows an apparatus for placement of a retaining clip 1 on a line element 2 shown with a dot-dash line, using a clamping device 3 for the retaining clip 1. The clamping device 3 has two clamping jaws 6, 7 arranged on a disk element 4, 5, in each instance. The disk elements 4, 5 have a central recess 8 for the line element 2 and an opening 9 for introduction of the line element 2. In this way, the disk elements 4, 5, with the opening 9, are configured in C shape. The disk elements 4, 5 can be rotated relative to one another and thereby move the clamping jaws 6, 7 toward one another or away from one another. In order to move the retaining clip 1 in the planned orientation relative to the line element 2, the disk elements 4, 5 can be rotated synchronously with the retaining clip 1. Furthermore, the disk elements 4, 5 can be moved in guides, not shown, perpendicular to the axis of the line element 2.

FIG. 2 shows the clamping jaws 6, 7 of the clamping device 3 from FIG. 1, with the retaining clip 1 before clamping, on a larger scale. The retaining clip 1 has a gripping region 10, a functional region 11 having two attachment bars 12, 13, and a fastening section 14. The fastening section 14 serves for fastening of the retaining clip 1 in a structure, not shown, for example a body panel of a motor vehicle, and has a hook-shaped profile. Alternatively, the fastening section 14 can also as a pine tree profile or have shanks having wraps, as known from the state of the art. The attachment bars 12, 13 serve for contact against the line element 2 shown in FIG. 1. The line element 2 can be attached to these attachment bars 12, 13 using adhesive tape, for example. Alternatively, the functional region 11 can also have engagement means or clamps for attachment to other components.

The gripping region 10 has two positioning elements 15, 16 that face away from one another and project. The positioning elements 15, 16 are arranged on a common axis shown with a dot-dash line. Furthermore, the positioning elements 15, 16 have a rectangular shape, in cross-section, of a pyramid stump, with ramps 17, 18 that extend over the entire circumference. Due to the rectangular shape, the positioning elements 15, 16 are structured to be non-round.

The clamping jaws 6, 7 of the clamping device 3 have clamping elements 19, 20 that are structured to correspond to the positioning elements 15, 16 of the retaining clip 1. The clamping elements 19, 20 have ramps 21, 22 that are structured to be complementary to the ramps 17, 18 of the retaining clip 1. The clamping elements 19, 20 are pressed against the positioning elements 15, 16 to grip the retaining clip 1, in the direction of their axes. As the result of the corresponding complementary shaping of the clamping elements 19, 20 and the positioning elements 15, 16, the retaining clip 1 is reliably clamped, centered, and oriented during gripping. The clamping elements 19, 20 have slits 23, 24 that are guided to the ramps 21, 22, and thereby allow a slight resilience.

FIGS. 3 and 4 show the retaining clip 1 in the state when it is clamped in place by the clamping device 3, in two views. The retaining clip 1 is held by the clamping device 3 in every spatial axis.

FIG. 5 shows a further embodiment of a retaining clip 101 and a clamping device 103, which differs from the one in FIGS. 1 to 4 in that the retaining clip 101 has a functional region 111 having a cable tie 125. To make it possible to hold the retaining clip 101 in the correct position, a gripping region 110 having two different positioning elements 115, 116 is configured to be asymmetrical. One of the positioning elements 115 is configured to project on one side of the gripping region 110, as was described in connection with FIG. 2. The positioning element 116 of the other side is configured to be set back, and has a funnel shape. The clamping device 103 has clamping elements 119, 120 that are configured complementary to the positioning elements 115, 116. As in the case of the embodiment according to FIGS. 2 to 4, ramps 119, 120 extend from clamping elements 106, 107, and ramps 117, 118 of the positioning elements 115, 116 extend over their entire circumference.

1. A retaining clip (1, 101) having a gripping region (10, 110) configured for being gripped by a clamping device (3, 103), wherein the gripping region (10, 110) has at least one projecting or set-back positioning element (15, 16, 115, 116), that at least one ramp (17, 18, 117, 118) extends over the entire circumference of the at least one positioning element (15, 16, 115, 116), and that the at least one ramp (17, 18, 117, 118) is inclined relative to the axis of the positioning element (15, 16, 115, 116).

2. The retaining clip according to claim 1, wherein the projecting positioning element (15, 16, 115) has an arched, cone-like or pyramid-like shape.

3. The retaining clip according to claim 1, wherein the set-back positioning element (116) has a funnel shape.

4. The retaining clip according to claim 1, wherein the at least one positioning element (15, 16, 115, 116) is configured to be non-round in cross-section.

5. The retaining clip according to claim 1. wherein at the retaining clip (1, 101) has a positioning element (15, 16, 115, 116), in each instance, on two sides that face away from one another.

6. The retaining clip according to claim 1, wherein the axes of the two positioning elements (15, 16, 115, 116) align.

7. The retaining clip according to claim 1, wherein the at least one positioning element (15, 16) projects away from an attachment bar (12, 13) that is provided for attachment to a line element (2).

8. The retaining clip according to claim 1, wherein the gripping region (10) of the retaining clip (1) is configured symmetrically, with two similar positioning elements (15, 16).

9. The retaining clip according to claim 1, wherein the gripping region (110) of the retaining clip (101) is configured asymmetrically.

10. A clamping device (3, 103) for clamping and orienting the one retaining clip (1, 101) according to claim 1, having two clamping jaws (6, 7, 106, 107) that can be moved relative to one another, wherein at least one of the clamping jaws (6, 7, 106, 107) has a clamping element (10, 20, 119, 120) that is configured to correspond to the positioning element (15, 16, 115, 116) of the retaining clip (1, 101).

11. The clamping device according to claim 10, wherein the at least one clamping element (10, 20, 119, 120) has ramps (21, 22, 121, 122) that are configured to be complementary to the ramps (17, 18, 117, 118) of the retaining clip (1, 101).

12. The clamping device according to claim 10, wherein the movement direction of the clamping elements (10, 20, 119, 120) runs in the axis direction of the at least one positioning element (15, 16, 115, 116) during gripping.

13. The clamping device according to claim 10, wherein at the clamping jaws (6, 7, 106, 107) each have a clamping element (10, 20, 119, 120).
